(19) United States
(12) Patent Application Publication
(10) Pub. No.: US 2025/0163949 A1
(43) Pub. Date: May 22, 2025

(54) Fastening Clip Assembly

(71) Applicant: Illinois Tool Works Inc., Glenview, IL (US)

(72) Inventors: Zhilin LI, Shanghai (CN); Weibin LIU, Shanghai (CN)

(21) Appl. No.: 18/945,112

(22) Filed: Nov. 12, 2024

(30) Foreign Application Priority Data
Nov. 20, 2023 (CN) 202311556493.2
Nov. 1, 2024 (CN) 202411554075.4

(51) Int. Cl. F16B 21/08

(52) U.S. Cl. CPC F16B 21/086

(57) ABSTRACT

The present disclosure provides a fastening clip assembly comprising a clip and an insert. The clip includes a pair of side walls and a head provided at first ends of the pair of side walls. The clip further includes an internal cavity between the pair of side walls, and the head is provided with an opening in communication with the internal cavity. The insert includes a pair of legs and a pair of latching arms respectively provided on outer sides of the pair of legs. The pair of legs are connected together at their proximal ends and form free ends at their distal ends. The pair of latching arms each is positioned between the respective proximal end and the respective distal end and extends toward the proximal end. The pair of legs are inserted at least partially into the internal cavity of the clip through the opening. The pair of latching arms are configured to, when the clip is in a use state, cooperate with the head of the clip to limit the withdrawal of the insert from the clip.

### RELATED APPLICATIONS

The present application claims the benefit of Chinese Patent Application Nos. 202311556493.2, filed Nov. 20, 2023, and 202411554075.4, filed Nov. 1, 2024, each titled “Fastening Clip Assembly,” the contents of which are hereby incorporated by reference.

### TECHNICAL FIELD

The present disclosure relates to a fastening clip assembly, and in particular, to a fastening clip assembly for attaching one or more components (e.g., an airbag device) to an external structure.

### BACKGROUND

A fastening clip assembly is used to quickly and reliably secure an additional part to a vehicle body. An exemplary application of the fastening clip assembly is to fasten an airbag device to a vehicle body part. In addition to the desire for the fastening clip assembly to fasten an airbag to the vehicle body part when the airbag is not deployed, it is also desirable to retain the airbag on the vehicle body component during the airbag is deployed.

### SUMMARY

The present disclosure relates generally to a fastening clip assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is a perspective view of a fastening clip assembly in a pre-assembled state according to one aspect of the present disclosure.

FIG. 2A is a perspective view of a clip of the fastening clip assembly shown in FIG. 1.

FIG. 2B is a cross-sectional view of the clip of the fastening clip assembly shown in FIG. 1.

FIG. 3 is a perspective view of an insert of the fastening clip assembly shown in FIG. 1.

FIG. 4A is a side view of the fastening clip assembly shown in FIG. 1 in the pre-assembled state.

FIG. 4B is a cross-sectional view taken along line A-A in FIG. 4A.

FIG. 5A is a side view of the fastening clip assembly shown in FIG. 1 in a use state.

FIG. 5B is a cross-sectional view taken along line B-B in FIG. 5A.

FIG. 6 is a perspective view of a fastening clip assembly in a pre-assembled state according to another aspect of the present disclosure.

FIG. 7A is a perspective view of a clip of the fastening clip assembly shown in FIG. 6.

FIG. 7B is a cross-sectional view of the clip of the fastening clip assembly shown in FIG. 6.

FIG. 7C is a bottom view of the clip of the fastening clip assembly shown in FIG. 6.

FIG. 8 is a perspective view of an insert of the fastening clip assembly shown in FIG. 6.

FIG. 9A is a side view of the fastening clip assembly shown in FIG. 6 in the pre-assembled state.

FIG. 9B is a cross-sectional view taken along line C-C in FIG. 9A.

FIG. 10A is a side view of the fastening clip assembly shown in FIG. 6 in a use state.

FIG. 10B is a cross-sectional view taken along line D-D in FIG. 10A.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a fastening clip assembly comprising a clip and an insert. The clip comprises a pair of side walls and a head provided at the first ends of the pair of side walls. The clip further comprises an internal cavity between the pair of side walls, and the head is provided with an opening in communication with the internal cavity. The insert comprises a pair of legs and a pair of latching arms respectively provided on outer sides of the pair of legs. The pair of legs are connected together at their proximal ends and form free ends at their distal ends. The pair of latching arms each are positioned between the respective proximal end and the respective distal end and extend toward the proximal end. The pair of legs are inserted at least partially into the internal cavity of the clip through the opening. The pair of latching arms are configured to, when the clip is in a use state, cooperate with the head of the clip to limit the withdrawal of the insert from the clip.

In the aspects of the fastening clip assembly according to the above, the clip further comprises a pair of retaining portions. The pair of retaining portions are respectively connected to second ends of the pair of side walls and protrude through the respective side wall. The pair of retaining portions are deflectable toward and away from each other. The insert further comprises a pair of verification elements provided at the distal ends of the pair of legs, respectively. The pair of verification elements are configured to respectively abut against the pair of retaining portions from the inside when the clip is in the use state.

In the aspects of the fastening clip assembly according to the above, the head comprises an inner surface facing the internal cavity, and the pair of latching arms are configured to abut against the inner surface to limit the withdrawal of the insert from the clip.

In the aspects of the fastening clip assembly according to the above, the fastening clip assembly further comprises a pair of additional latching arms being respectively provided on outer sides of the pair of legs between the pair of latching arms and the distal ends and extending toward the pair of latching arms. The pair of additional latching arms are configured to, when the clip is in the use state, cooperate with the pair of side walls of the clip, respectively, to further limit the withdrawal of the insert from the clip.

In the aspects of the fastening clip assembly according to the above, the pair of side walls are each provided with a limiting groove, and the pair of additional latching arms cooperate with the limiting grooves of the pair of side walls, respectively.

In the aspects of the fastening clip assembly according to the above, free ends of the pair of additional latching arms are each provided with a foot, and the limiting grooves of the pair of side walls are sized to be capable of receiving the feet, but not the rest of the respective additional latching arms.

In the aspects of the fastening clip assembly according to the above, the head is further provided with a pair of extension grooves on opposite sides of the opening and in communication with the opening, the pair of extension grooves being sized to allow the feet of the pair of additional latching arms to pass therethrough, but not free ends of the pair of latching arms to pass therethrough.

In the aspects of the fastening clip assembly according to the above, the pair of latching arms have widened free ends.

In the aspects of the fastening clip assembly according to the above, each of the pair of legs is provided with an outwardly-protruding limiting boss on an outer side of the proximal end thereof.

In the aspects of the fastening clip assembly according to the above, the limiting grooves of the pair of side walls are configured to receive the pair of verification elements, respectively, to pre-assemble the insert in the clip.

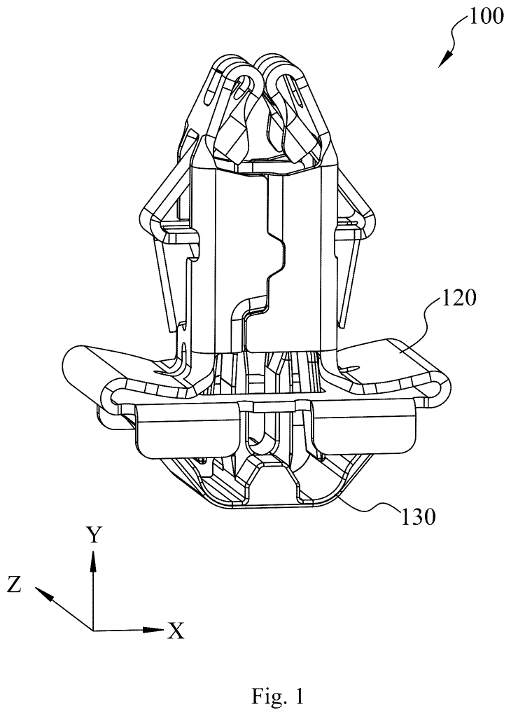

FIG. 1 shows the overall structure of a fastening clip assembly 100 according to one aspect of the present disclosure. In FIG. 1, the fastening clip assembly 100 is in a pre-assembled state. The fastening clip assembly 100 can be inserted into a hole in a vehicle part (e.g., a vehicle sheet metal) to fasten an accessory, such as an airbag, to the vehicle part. For convenience of illustration, the various directions of the fastening clip assembly 100 are represented by the coordinate system in FIG. 1. The X-axis direction represents the width direction of the fastening clip assembly 100, the Y-axis direction represents the length direction of the fastening clip assembly, and the Z-axis direction represents the thickness direction of the fastening clip assembly. The above directions are relative and cannot be regarded as limiting the present disclosure.

As shown in FIG. 1, the fastening clip assembly 100 includes a clip 120 and an insert 130. The clip 120 is used to engage the fastening clip assembly 100 with a vehicle part (e.g., a plate having a hole) when in a use state, and the insert 130 is used to maintain an engagement state of the clip 120 with the vehicle component. In the pre-assembled state, insert 130 is assembled on the clip 120 and retained on the clip 120 so that they form an assembly that is pre-assembled together. The clip 120 is made of a metal material, and the insert 130 is made of a plastic material. The fastening clip assembly 100 in the pre-assembled state is suitable for sale, transportation, etc. of the fastening clip assembly 100.

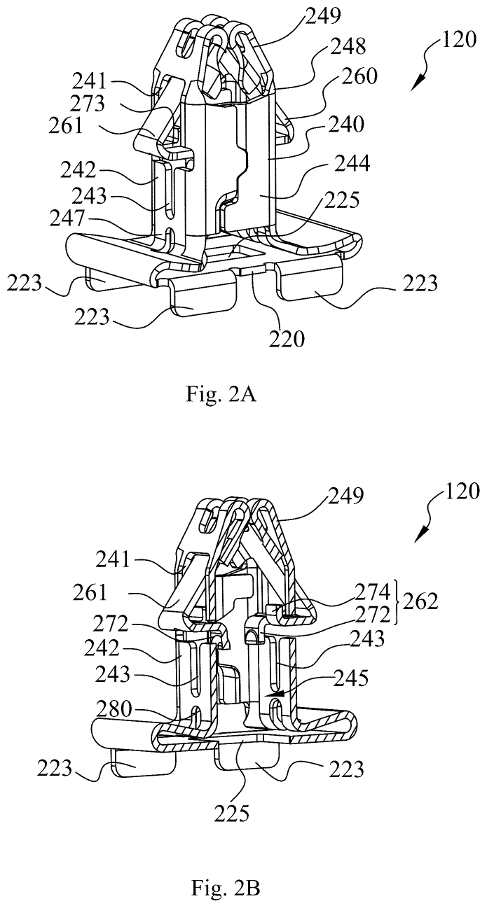

FIGS. 2A and 2B show the specific structure of the clip 120. FIG. 2A is a perspective view of the clip 120, and FIG. 2B is a cross-sectional view of the clip 120. As shown in FIGS. 2A and 2B, the clip 120 includes a head 220, a main body 240, and a pair of retaining portions 260. The clip 120 is made of a metal material such as steel by bending, stamping, shearing and other processes. The pair of retaining portions 260 are deflectable relative to each other.

The main body 240 includes two pairs of side walls, namely, a first pair of side walls 242 and a second pair of side walls 244, the two pairs of side walls are disposed opposite each other. The main body 240 defines an internal cavity 245 of the clip 120 that is located between the first pair of side walls 242 and between the second pair of side walls 244. The first pair of side walls 242 are each provided with a window 241 communicating the internal cavity 245 of the clip 120 with the outside. The first pair of side walls 242 are each further provided with a limiting groove 243 extending in the length direction, and the limiting groove 243 is located below a respective window 241 and in communication with the window 241. In addition, the clip 120 includes receiving grooves 280 each of which is provided at the connection between a respective one of the first pair of side walls 242 and the head 220. The first pair of side walls 242 each include a first end 247 and a second end 248 opposite to each other. The first pair of side walls 242 each further include a side wall extension 249 provided at the second end 248 thereof, which is slightly inclined inwardly relative to the side wall 242.

The head 220 is generally flat. The head 220 is connected to the first ends 247 of the first pair of side walls 242 and provided with an opening 225. The opening 225 is in communication with the internal cavity 245. The head 220 thus protrudes outwardly relative to the first pair of side walls 242. In some aspects, the head 220 extends in a direction perpendicular to the side walls 242.

The pair of retaining portions 260 are respectively connected to the side wall extensions 249 at the second ends 248 of the first pair of side walls 242. The retaining portions 260 extend from the side wall extensions 249 and are bent in a special manner. The retaining portions 260 each includes a retaining section 261 and a free end section 262, the retaining section 261 is adjoined to the respective side wall extension 249.

The retaining sections 261 of the two retaining portions 260 each extend from the side wall extension 249 of the respective side wall 242 toward the head 220, and a part of the retaining section 261 extends obliquely outwardly from the internal cavity 245 of the clip 120 through the respective window 241, i.e., protruding through the window 241. The retaining section 261 is bent back after extending outwardly and extends in the width direction, such that the end section 262 connected thereto returns into the internal cavity 245 of the clip 120. Thus, the retaining section 261 includes an inclined portion and a transversely extending portion which form an acute angle to each other. The transversely extending portion extends in the width direction. The pair of retaining portions 260 can be deflected toward and away from each other so that the retaining sections 261 of the pair of retaining portions 260 can protrude from the respective windows 241, and can also return into the internal cavity 245 of the clip 120.

The retaining portions 260 are each provided with a cutout 273. The cutout 273 extends in the width direction to divide the transversely extending portion of the retaining section 261 and the end section 262 into two parts. Each end section 262 includes a driving portion 272 and a blocking portion 274 separated by the cutout 273. The driving portion 272 extends from the retaining section 261 toward the head 220, and the blocking portion 274 extends from the retaining section 261 away from the head 220. The driving portions 272 of the two retaining portions 260 are offset in the thickness direction, and are located on opposite sides of the cutout 273. The blocking portion 274 can hook onto an edge of the window 241 of the side wall 242 to increase the retention force of the retaining portion 260.

The clip 130 further includes a plurality of baffles 223 provided on the head 220, which are provided on widthwise extending edges of the head 220 and extend downwardly from the head 220, for isolating the insert 130 of the fastening clip assembly 100 from a part to be fastened (e.g., an airbag) in the use state of the fastening clip assembly 100.

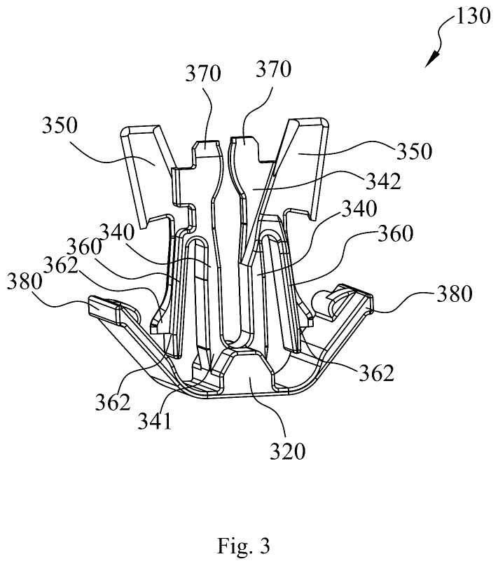

FIG. 3 is a perspective view of the insert 130 of the fastening clip assembly 100 shown in FIG. 1, showing the specific structure of the insert 130. As shown in FIG. 3, the insert 130 includes a base 320, a pair of legs 340, a pair of verification elements 350, a pair of latching arms 360, a pair of driven pieces 370, and a pair of wings 380.

The pair of legs 340 extend from the base 320 and extend generally in the length direction. In an unstressed free state of the insert 130, there is a certain distance between the pair of legs 340. Proximal ends 341 of the pair of legs 340 are connected to the base 320, and the pair of legs 340 can be deflected toward and away from each other about their proximal ends 341.

The pair of verification elements 350 are provided at distal ends 342 of the pair of legs 340, respectively, and extend and protrude outwardly from the respective legs 340. The pair of driven pieces 370 are also provided at the distal ends 342 of the pair of legs 340, respectively, and the pair of driven pieces 370 are located between the pair of verification elements 350 in the width direction.

Still referring to FIG. 3, the pair of latching arms 360 are connected to the pair of legs 340, respectively, and are located on outer sides of the legs 340. The latching arms 360 are each connected, via its proximal end, to the respective leg 340 in a position near the distal end 342 of the leg 340. The latching arm 360 extends downwardly toward the base 320 and can be deflected toward and away from the respective leg 340. The distal end of the latching arm 360 is provided with a foot 362. The foot 362 is generally hook-shaped. The pair of wings 380 are connected to opposite sides of the base 320 and can be deflected relative to the base 320. In the unstressed free state, the pair of wings 380 together form a V-shape.

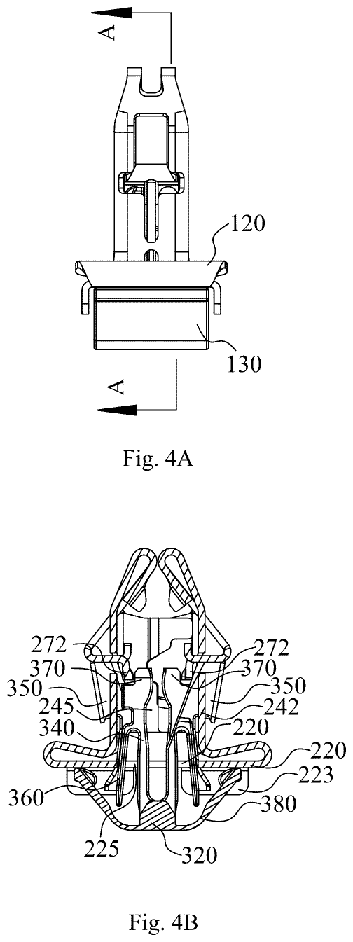

FIGS. 4A and 4B show the cooperating relationship between the clip 120 and the insert 130 when the fastening clip assembly 100 is in the pre-assembled state. FIG. 4A is a side view of the fastening clip assembly 100, and FIG. 4B is a cross-sectional view taken along line A-A in FIG. 4A. As shown in FIGS. 4A and 4B, when the fastening clip assembly 100 is in the pre-assembled state, the legs 340 of the insert 130, together with the verification elements 350, the latching arms 360 and the driven pieces 370 connected thereto, pass through the opening 225 of the head 220 of the clip 120 into the internal cavity 245 of the clip 120, while the base 320 and the wings 380 of the insert 130 cannot enter the opening 225, but are blocked outside the internal cavity 245 by the head 220. The pair of verification elements 350 extend out of the internal cavity 245 through the limiting grooves 243 of the pair of side walls 242 of the clip 120, respectively, such that the verification elements 350 cooperate with the limiting grooves 243 to limit the withdrawal of the insert 130 from the clip 120, thereby retaining the insert 130 on the clip 120 to make the two form a pre-assembly.

During pre-assembling of the insert 130 to the clip 120, the pair of verification elements 350 first come into contact with a pair of edges of the opening 225 of the head 220 of the clip 120 that extend in the thickness direction. Since in the unstressed state, the distance between outer side surfaces of the pair of verification elements 350 is greater than the distance between the pair of edges of the opening 225 that extend in the thickness direction, it is necessary for an operator to first apply forces to the pair of legs 340 to deflect them toward each other, so as to reduce the distance between the outer side surfaces of the pair of verification elements 350 to allow them to enter the opening 225. After the pair of verification elements 350 enter the opening 225, the pair of edges of the opening 225 that extend in the thickness direction apply forces to the verification elements 350, to keep the pair of legs 340 in a state of being deflected toward each other. When the pair of verification elements 350 pass through the opening 225 and are aligned with the limiting grooves 243 of the side walls 242, the legs 340 are no longer subjected to the forces for deflecting them toward each other, and the verification elements 350 move outwardly to pass through the limiting grooves 243 of the side walls 242 under the spring-back force of the legs 340, to reach the outside of the internal cavity 245, thereby retaining the insert 130 on the clip 120.

As still shown in FIG. 4B, when the fastening clip assembly 100 is in the pre-assembled state, the pair of driven pieces 370 of the insert 130 are respectively aligned with the respective driving portions 272 such that when the pair of driving portions 272 move toward each other, the pair of driving portions 272 can drive the respective driven pieces 370, respectively, causing the pair of driven pieces 370 to also move toward each other. In addition, parts of the pair of latching arms 360 remains within the opening 225 and are pressed by the pair of edges of the opening 225 that extend in the thickness direction to be deflected toward each other.

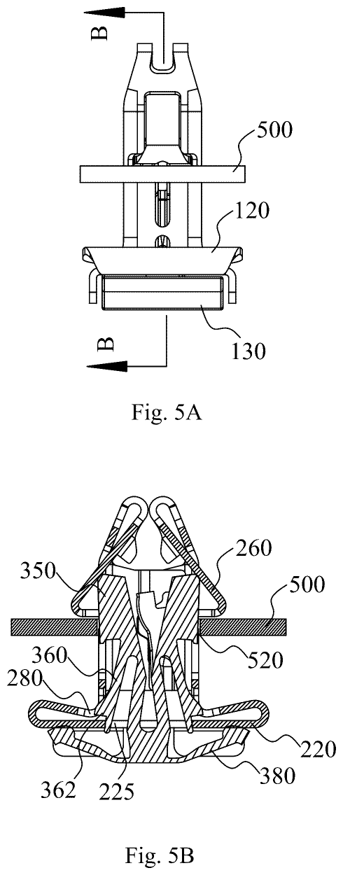

FIGS. 5A and 5B show the cooperating relationship between the clip 120 and the insert 130 when the fastening clip assembly 100 is in the use state. FIG. 5A is a side view of the fastening clip assembly 100, and FIG. 5B is a cross-sectional view taken along line B-B in FIG. 5A. In the use environment shown in FIGS. 5A and 5B, the fastening clip assembly 100 fastens a part (e.g., an airbag) to a plate 500, and at least a part of the fastening clip assembly 100 passes through a hole 520 of the plate 500.

As shown in FIG. 5B, when the fastening clip assembly 100 is in the use state, the retaining portions 260 of the clip 120 pass through the hole 520 of the plate 500 and are located above the plate 500. The pair of wings 380 abut against the head 220 and are deployed. The feet 362 of the pair of latching arms 360 are engaged with the edges of the opening 225 of the head 220 of the clip 120, and parts of the feet are accommodated in the receiving grooves 280 of the head 220. The pair of verification elements 350 are located between and abut against the inclined portions of the retaining sections 261 of the retaining portions 260 of the clip 120. The cooperating relationship described above limits the withdrawal of the insert 130 from the clip 120, thereby limiting the movement of the retaining portions 260 of the clip 120 toward each other and out of the hole 520, thereby enabling the clip 120 and the fastening clip assembly 100 to be retained in the use state.

During the process of transitioning the fastening clip assembly 100 from the pre-assembled state shown in FIGS. 4A and 4B to the use state shown in FIGS. 5A and 5B, the retaining portions 260 of the clip 120 are first deflected (moved) toward each other under the action of a pair of edges of the holes 520 of the plate 500, such that the retaining portions 260 gradually pass through the hole 520. During this process, the driven portions 370 of the insert 130 causes the pair of legs 340 to be deflected toward each other under the action of the driving portions 272 of the retaining portions 260 of the clip 120, thereby causing the pair of verification elements 350 to also move toward each other and away from the limiting grooves 243 of the side walls 242. Before the retaining portions 260 of the clip 120 completely pass through the hole 520, the driven portions 370 of the insert 130 both remain engaged with the driving portions 272 of the retaining portions 260 of the clip 120. Therefore, when the retaining portions 260 of the clip 120 move toward each other to completely pass through the hole 520, the pair of verification elements 350 can also enter the hole 520, and the pair of verification elements 350 are located exactly in the hole 520. After the retaining portions 260 of the clip 120 have completely passed through the hole 520, the retaining portions 260 are sprung outwardly under the action of elastic force, and the pair of verification elements 350 are engaged with the edges of the hole 520, so that the pair of legs 340 are still in the state of being deflected toward each other due to the effect of the edges of the hole 520. Thus, the driven portions 370 of the insert 130 are disengaged from the driving portions 272 of the retaining portions 260 of the clip 120, which enables the insert 130 to move relative to the clip 120 toward the plate 500 and be further inserted into the internal cavity 245 of the clip 120, thereby reaching the use state shown in FIG. 5B. In the state shown in FIG. 5B, the pair of verification elements 350 of the insert 130 abut against the inclined portions of the retaining sections 261 of the pair of retaining portions 260, respectively.

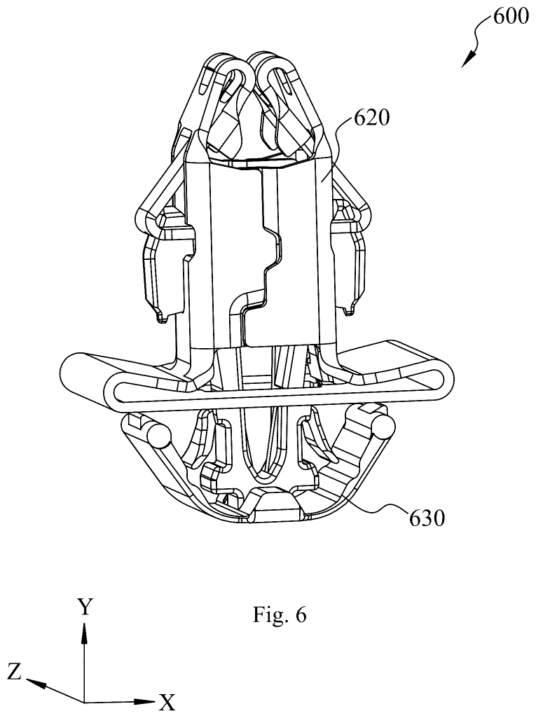

FIG. 6 shows the overall structure of a fastening clip assembly 600 according to another aspect of the present disclosure. As shown in FIG. 6, the fastening clip assembly 600 includes a clip 620 and an insert 630. The fastening clip assembly 600 in the aspect shown in FIG. 6 is similar to the fastening clip assembly 100 in the aspect shown in FIG. 1, with the main difference being that the fastening clip assembly 100 is provided with a pair of latching arms 360, while the fastening clip assembly 600 is provided with a pair of additional latching arms in addition to the pair of latching arms.

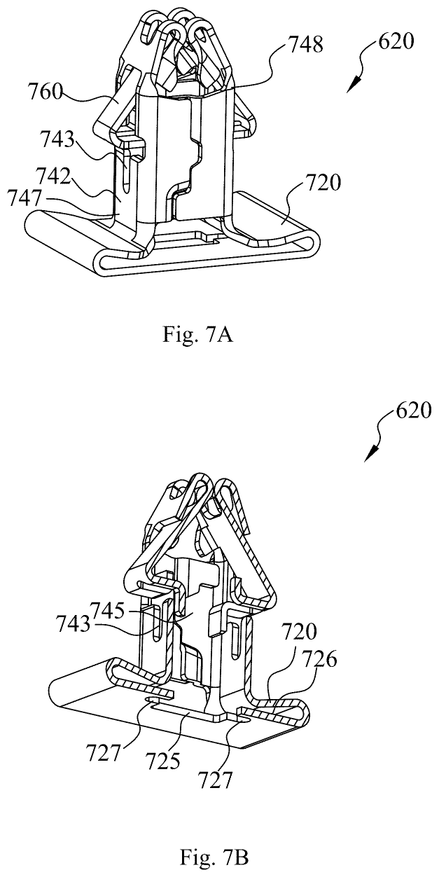

FIGS. 7A to 7C show the specific structure of the clip 620 of the fastening clip assembly 600 in FIG. 6, the structure of the clip 620 being generally similar to that of the clip 220 shown in FIGS. 2A and 2B, with the main difference being that the side walls 742 of the clip 620 are not additionally provided with the receiving grooves. In addition, the clip 620 is provided with extension grooves 727 at a pair of side portions of the hole 725 of the head 720, with the pair of extension grooves 727 being in communication with the hole 725. Like the clip 220, the head 720 and the retaining portions 760 of the clip 620 are connected to the first ends 747 and the second ends 748, respectively, of the pair of side walls 742. For other specific structures of the clip 620, reference is made to the detailed description of the clip 220 above, which will not be repeated here.

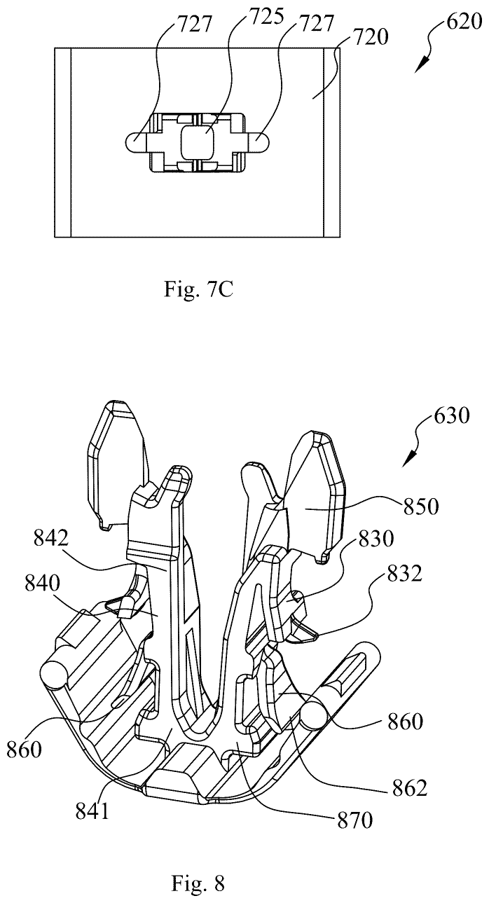

FIG. 8 shows the specific structure of the insert 630 of the fastening clip assembly 600 in FIG. 6, the structure of the insert 630 being substantially similar to that of the insert 230 shown in FIG. 3, with the main difference being that the legs 340 of the insert 230 are provided with a pair of latching arms 360, while the legs 840 of the insert 630 are provided with a pair of latching arms 860 and a pair of additional latching arms 830 between the proximal ends 841 and the distal ends 842 thereof, with the pair of latching arms 860 and the pair of additional latching arms 830 both extending toward the proximal ends 841 of the legs 840.

As shown in FIG. 8, the additional latching arms 830 are located above the latching arms 860, i.e., between the latching arms 860 and the distal ends 842 of the legs 840. The additional latching arms 830 each include a foot 832 provided at its free end. Unlike the hook-shaped foot of the latching arm 330 of the insert 230 in the aspect shown in FIG. 3, the foot 832 of the additional latching arm 830 is not hook-shaped. The foot 832 of the additional latching arm 830 is smaller than the width of the rest of the additional latching arm 830. The latching arm 860 is gradually widened from its end, to which the leg 840 is connected, to the free end 862, so that the latching arm 860 has a widened free end 862. The width of the free end 862 of the latching arm 860 is greater than the width of the foot 832 of the additional latching arm 830. The width of the foot and the free end referred to above is the dimension of the foot and the free end in the thickness direction of the fastening clip assembly. The above configuration of the latching arms 860 and the additional latching arms 830 of the insert 630 allows the latching arms 860 and the additional latching arms 830 to have a relatively large strength, so that a large retention force can be provided.

The limiting grooves 743 of the side walls 742 of the clip 620 are sized to be capable of receiving the feet 832 of the additional latching arms 830, but not the rest of the additional latching arms 830. Moreover, the limiting grooves 743 are sized to be capable of receiving the verification portions 850 of the insert 630 to pre-assemble the insert 630 in the clip 620.

In addition, the extension grooves 727 of the head 720 of the clip 620 are sized to allow the feet 832 of the additional latching arms 830 to pass therethrough, but not the free ends 862 of the latching arms 860 to pass therethrough.

Still referring to FIG. 8, an outwardly-protruding limiting boss 870 is provided on an outer side of the proximal end 841 of each of the pair of legs 840 of the insert 630.

For other specific structures of the insert 630, reference is made to the detailed description of the insert 230 above, which will not be repeated here.

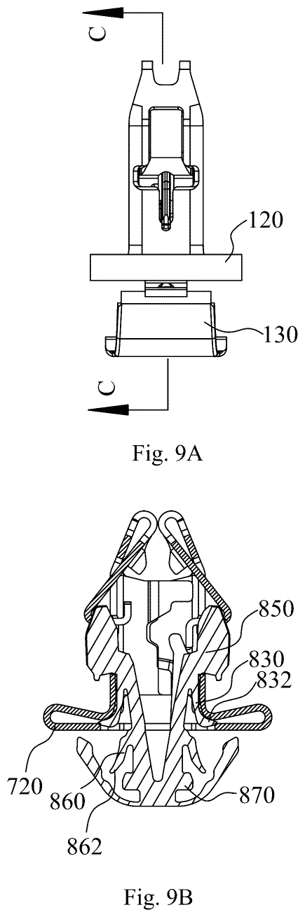

FIGS. 9A and 9B show the cooperating relationship between the clip 620 and the insert 630 when the fastening clip assembly 600 is in the pre-assembled state, and the manner in which the insert 630 is retained on the clip 620 is the same as the manner in which the insert 130 is retained on the clip 120 shown in FIGS. 4A and 4B, and will not be repeated here.

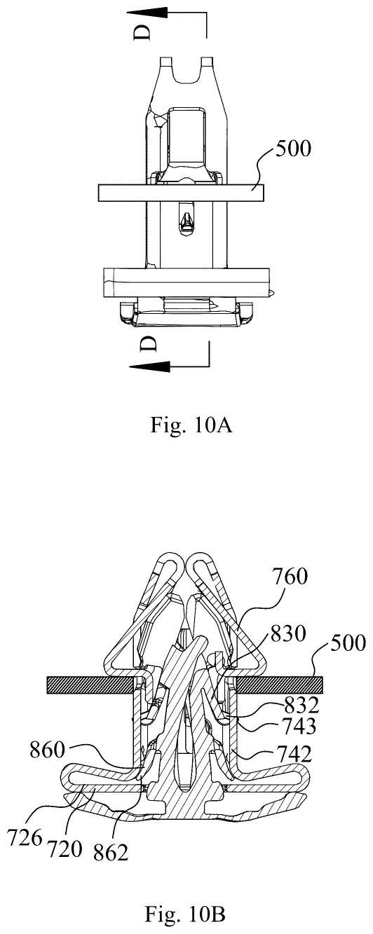

FIGS. 10A and 10B show the cooperating relationship between the clip 620 and the insert 630 when the fastening clip assembly 600 is in the use state. As shown in FIGS. 10A and 10B, when the fastening clip assembly 600 is in the use state, the feet 832 of the additional latching arms 830 are received in the limiting grooves 743 of the clip 620, the rest of the additional latching arms 830 cannot enter the limiting grooves 743, and the free ends 862 of the latching arms 860 are adjacent to or engaged with an inner surface 726 of the head 720 of the clip 620. Thus, when the insert 630 is subjected to an outward withdrawal force, by the cooperation between the latching arms 860 and the head 720, and by the cooperation between the additional latching arms 830 and the side walls 742, the latching arms 860 and the additional latching arms 830 can be retained in the internal cavity 745 of the clip 620, so that the insert 630 can prevent the retaining portions 760 of the clip 620 from being withdrawn from the hole of the component 500, thereby retaining the fastening clip assembly 600 in the use state.

As still shown in FIGS. 10A and 10B, when the fastening clip assembly 600 is in the use state, the limiting bosses 870 on the pair of legs 840 of the insert 630 are accommodated in the opening 725 of the head 720 of the clip 620. Since the opening 725 is sized such that the latching arms 860 and the additional latching arms 830 of the insert 630 can pass therethrough, if there were no limiting bosses 870, there will be a large gap between the opening 725 and the legs 840 after the latching arms 860 and the additional latching arms 830 pass through the opening 725, which will cause the insert 630 to wobble in the clip 620. By providing the limiting bosses 870 and by sizing the limiting bosses 870 to enable it to cooperate with the edges of the opening 725 in the thickness direction, the wobble of the insert 630 in the clip 620 can be limited.

By providing the legs of the insert with the latching arms that cooperate with the head of the clip, the fastening clip assembly of the present disclosure can not only retain the fastening clip assembly in the use state, but can also achieves a simple structure for the cooperation between the latching arms and the clip which can be easily detected. Furthermore, the cooperation between the latching arms and the clip of the fastening clip assembly of the present disclosure is robust and reliable, so that the fastening clip assembly can withstand the large tensile force applied by the deployment of the airbag when used to fasten the airbag, and is retained in the use state without being withdrawn from the hole in the component.

Although the present disclosure is described in conjunction with the examples of aspects outlined above, various alternatives, modifications, variations, improvements, and/or substantial equivalents, whether known or now or hereafter foreseeable, may be obvious to those of at least ordinary skill in the art. In addition, the technical effects and/or technical problems described in this specification are exemplary rather than limiting. Therefore, the disclosure in this specification may be used to solve other technical problems and have other technical effects and/or may solve other technical problems. Accordingly, the examples of the aspects of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

What is claimed is:

1. A fastening clip assembly, comprising:
a clip comprising a pair of side walls and a head provided at first ends of the pair of side walls, the clip further comprising an internal cavity between the pair of side walls, and the head being provided with an opening in communication with the internal cavity; and
an insert comprising a pair of legs and a pair of latching arms respectively provided on outer sides of the pair of legs, the pair of legs being connected together at their proximal ends and forming free ends at their distal ends, and the pair of latching arms each being positioned between the respective proximal end and the respective distal end and extending toward the proximal end, wherein the pair of legs are inserted at least partially into the internal cavity of the clip through the opening, and the pair of latching arms are configured to, when the clip is in a use state, cooperate with the head of the clip to limit withdrawal of the insert from the clip.

2. The fastening clip assembly according to claim 1, wherein
the clip further comprises a pair of retaining portions, the pair of retaining portions being respectively connected to second ends of the pair of side walls, and protruding through the respective side wall, wherein the pair of retaining portions are deflectable toward and away from each other; and
the insert further comprises a pair of verification elements provided at the distal ends of the pair of legs, respectively, the pair of verification elements being configured to respectively abut against the pair of retaining portions from the inside when the clip is in the use state.

3. The fastening clip assembly according to claim 2, wherein
the head comprises an inner surface facing the internal cavity, and the pair of latching arms are configured to abut against the inner surface to limit the withdrawal of the insert from the clip.

4. The fastening clip assembly according to claim 3, further comprising:
a pair of additional latching arms being respectively provided on outer sides of the pair of legs between the pair of latching arms and the distal ends, and extending toward the pair of latching arms, and the pair of additional latching arms being configured to, when the clip is in the use state, cooperate with the pair of side walls of the clip, respectively, to further limit the withdrawal of the insert from the clip.

5. The fastening clip assembly according to claim 4, wherein
the pair of side walls are each provided with a limiting groove, and the pair of additional latching arms cooperate with the limiting grooves of the pair of side walls, respectively.

6. The fastening clip assembly according to claim 5, wherein
free ends of the pair of additional latching arms are each provided with a foot, and the limiting grooves of the pair of side walls are sized to be capable of receiving the foot, but not the rest of the respective additional latching arms.

7. The fastening clip assembly according to claim 6, wherein
the head is further provided with a pair of extension grooves on opposite sides of the opening and in communication with the opening, the pair of extension grooves being sized to allow each foot of the pair of additional latching arms to pass therethrough, but not free ends of the pair of latching arms to pass therethrough.

8. The fastening clip assembly according to claim 1, wherein
the pair of latching arms have widened free ends.

9. The fastening clip assembly according to claim 1, wherein
each of the pair of legs is provided with an outwardly-protruding limiting boss on an outer side of the proximal end thereof.

10. The fastening clip assembly according to claim 6, wherein
the limiting grooves of the pair of side walls are configured to receive the pair of verification elements, respectively, to pre-assemble the insert in the clip.
